(19) United States
(12) Patent Application Publication
(10) Pub. No.: US 2023/0319368 A1
(43) Pub. Date: Oct. 5, 2023

(54) PACKET LOSS RECOVERY DEVICE AND METHOD USING CACHE SERVER

(71) Applicant: SK TELECOM CO., LTD., Seoul (KR)

(72) Inventors: Hyun Chul JOO, Seoul (KR); Dai Boong LEE, Seoul (KR)

(21) Appl. No.: 17/928,459

(22) PCT Filed: Jun. 16, 2021
(86) PCT No.: PCT/KR2021/007521

§ 371 Date: Nov. 29, 2022

(30) Foreign Application Priority Data
Jun. 17, 2020 (KR) 10-2020-0073703

(51) Int. Cl. H04N 21/643; H04N 21/43; H04N 21/6408

(52) U.S. Cl. CPC H04N 21/64322; H04N 21/6408; H04N 21/4305

(57) ABSTRACT

The present disclosure in some embodiments provides a packet loss recovery apparatus and a packet loss recovery method for use in an Internet Protocol Television (IPTV) multicast service, which utilizes additional information received from an IPTV UE for causing a cache server to detect and transmit a lost packet to the IPTV UE to recover the packet loss.

### TECHNICAL FIELD

The present disclosure in some embodiments relates to a packet loss recovery apparatus and method using a cache server. More particularly, the present disclosure relates to an Internet Protocol Television (IPTV) multicast service and provides a packet loss recovery apparatus and a packet loss recovery method for allowing a cache server to identify a lost packet by using additional information received from an IPTV User Equipment (UE) and send the IPTV UE a recovery packet corresponding to the lost packet.

### BACKGROUND

The statements in this section merely provide background information related to the present disclosure and do not necessarily constitute prior art.

Based on advanced networking technology, TV channels are being serviced using IPTV multicast to save network resources and support multiple subscribers at the same time. For this purpose, various IPTV UEs are now released from various manufacturers. Due to noise, network line congestion, etc., the IP network resides in an environment prone to errors. Accordingly, there is no escape from some packet loss due to the occurrence of an error, and such packet loss causes serious degradation of audio/video (A/V) quality. The quality degradation issue is a major Quality of Experience (QoE) factor of IP TV services.

To effectively handle packet loss in multicast transmission, Forward Error Correction (FEC) or Automatic Repeat reQuest (ARQ) techniques are widely used in an application layer. The FEC technique uses additional information to compensate for packet loss. By appropriately selecting the amount of additional information, the FEC technique can mitigate packet loss without a separate feedback channel at the client end. For example, packet loss can be overcome by using a Fountain code and/or a Reed-Solomon code during IPTV multicast. However, for the FEC technique to be applied to the IPTV multicast service, the cost undesirably increases due to the replacement of the pre-arranged broadcasting equipment while requiring a high computing power in the IPTV UE.

On the other hand, the IPTV multicast service with the ARQ technique applied suffers from an increased delay depending on the time taken from a retransmission request to receiving the requested packet. Additionally, as the number of IPTV subscribers scales up, the ARQ technique problematically increases uplink/downlink traffic.

Among other techniques, there is one in which a cache server detects which packet is lost by using a sequence number included in a Real-Time Transport Protocol (RTP) packet and retransmits the packet (as seen in Non-patent document 1). However, these techniques can be applied limited to an operation scenario using RTP, and they are impractical due to the lack of interchangeable detailed information between the cache server and the IPTV UE.

Therefore, there is a need in the IPTV multicast service for a packet loss recovery method that can be practically implemented while coping with the cost, computing power, and delay issues as described above.

### PRIOR ART LITERATURE

### Non-Patent Documents

Non-patent document 1: “Preserving Video Quality in IPTV Networks”, Cisco White Paper. Available online: http://www.webtorials.com/main/resource/papers/cisco/paper117/IPTV-quality.pdf

### DISCLOSURE

### Technical Problem

The present disclosure in some embodiments seeks to provide, in an IPTV multicast service, a packet loss recovery apparatus and a packet loss recovery method for allowing a cache server to identify a lost packet by using additional lost-packet information received from an IPTV UE and send the IPTV UE a recovery packet corresponding to the lost packet.

### SUMMARY

At least one aspect of the present disclosure provides a method performed by a cache server for recovering a packet loss, including receiving, from an internet protocol television (IPTV) user equipment (UE), additional information on a lost TS packet from among received transport stream (TS) packets of the IPTV UE, setting a search section in a pre-stored sequence of transmitted TS packets by using the additional information, and identifying the lost TS packet by searching over the search section, and extracting, from the search section, a recovery packet corresponding to the lost TS packet and transmitting the recovery packet to the IPTV UE in a unicast manner.

Another aspect of the present disclosure provides a method performed by an internet protocol television (IPTV) user equipment (UE), including checking whether a continuity error occurs by using header information of received transport stream (TS) packets, determining a packet loss section by using header information of the received TS packets related to the continuity error, generating, based on the packet loss section, additional information necessary for recovering a lost TS packet and transmitting a generated additional information to a cache server, and recovering the lost TS packet by using a recovery packet obtained from the cache server.

Yet another aspect of the present disclosure provides a non-transitory computer-readable medium storing computer-executable instructions, when being executed in a computer, cause the computer to perform receiving, from an internet protocol television (IPTV) user equipment (UE), additional information on a lost TS packet from among received transport stream (TS) packets of the IPTV UE, setting a search section in a pre-stored sequence of transmitted TS packets by using the additional information, and identifying the lost TS packet by searching over the search section, and extracting, from the search section, a recovery packet corresponding to the lost TS packet and transmitting the recovery packet to the IPTV UE in a unicast manner.

### Advantageous Effects

As described above, as provided for use in an IPTV multicast service according to embodiments of the present disclosure, the packet loss recovery apparatus and method can allow a cache server to identify a lost packet by using additional lost-packet information received from an IPTV UE and send the IPTV UE a recovery packet corresponding to the lost packet and thereby recovering the packet loss in the multicast service process.

Further, as provided for use in the IPTV multicast service according to embodiments of the present disclosure, the packet loss recovery apparatus and method can allow the cache server to identify a lost packet by using additional lost-packet information received from an IPTV UE and send the IPTV UE a recovery packet corresponding to the lost packet and thereby allowing the use of the User Datagram Protocol (UDP) method, wherein the structural characteristics of Transport Stream (TS) packets provide a basis for obtaining accurate detection and transmission of the lost packet.

### BRIEF DESCRIPTION OF THE DRAWINGS

FIG. 1 is a block diagram of a packet loss recovery apparatus according to at least one embodiment of the present disclosure.

FIG. 2 is a schematic diagram of a packet loss section according to at least one embodiment of the present disclosure.

FIG. 3 is a schematic diagram of additional information according to at least one embodiment of the present disclosure.

FIGS. 4A and 4B are flowcharts of a packet loss recovery method according to at least one embodiment of the present disclosure.

FIG. 5 is a schematic diagram of a configuration of an IPTV service system.

FIG. 6 is a schematic block diagram of an IP packet obtained by encapsulating TS packets.

FIGS. 7A and 7B illustrate examples of header information of TS packets received by an IPTV UE.

[REFERENCE NUMERALS]

| | |
|---|---|
| 100: PLR server | 102: packet recovery search unit |
| 104: packet recovery-control unit | 120: PLR client |
| 122: continuity error-monitoring unit | 124: packet loss section-setting |
| | unit |
| 126: additional information-generation | |
| unit | |
| 128: packet loss recovery-control unit | |

### DETAILED DESCRIPTION

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary. The terms such as “unit,” “module,” and the like refer to one or more units for processing at least one function or operation, which may be implemented by hardware, software, or a combination thereof.

The description of the present disclosure to be presented below in conjunction with the accompanying drawings is intended to describe exemplary embodiments of the present disclosure and is not intended to represent the only embodiments in which the technical idea of the present disclosure may be practiced.

The present disclosure presents the packet loss recovery apparatus and method using a cache server. More specifically, the present disclosure provides, for use in an IPTV multicast service, a packet loss recovery apparatus and a packet loss recovery method for allowing a cache server to identify a lost packet by using additional lost-packet information received from an IPTV UE and send the IPTV UE a recovery packet corresponding to the lost packet.

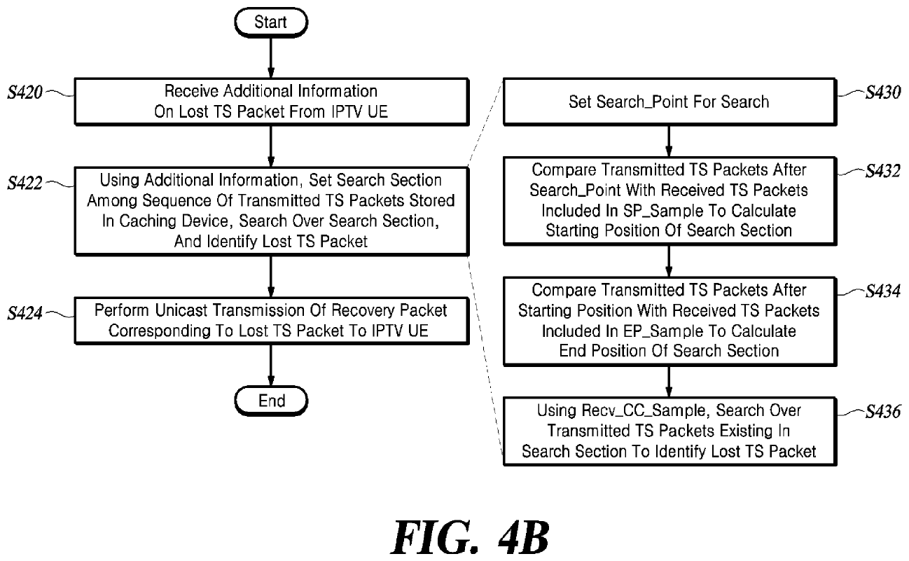

FIG. 5 is a schematic diagram of a configuration of an IPTV service system.

The IPTV service system generally includes a content-providing apparatus, IPTV UEs, an aggregation router/aggregation switches, and a cache server in whole or in part.

The content-providing apparatus transmits the content of all TV channels to a plurality of IPTV UEs with a multicast method by using an IPTV backbone network and a router/switches. Here, the content-providing apparatus may be an IPTV headend.

A user owning an IPTV UE may select the desired TV channel and watch the selected content. The TV channel content is provided in the form of packets, and the IPTV UE may also be referred to as a packet receiving terminal. The IPTV UE may be a set-top box (STB) type terminal, but is not necessarily limited thereto, and may include a mobile terminal such as a smartphone, a tablet, a notebook, and the like.

The cache server may be located in the local network close to the IPTV UEs, store the content provided from the IPTV headend to the IPTV UEs, and utilize the stored content to cope with packet loss that may occur in the IPTV UEs. Therefore, in the present embodiment, the cache server and the IPTV UE may be used to implement the packet loss recovery apparatus.

The IPTV headend formulates content for IPTV based on Moving Pictures Expert Group (MPEG)-2 transport stream (hereinafter ‘TS’) packets and provides the content by using an internet protocol (IP) network.

A TS is a multiplexed bitstream of packetized elementary stream (PES) packets representing image signals, audio signals, and data signals. Here, the PES packets are made for the convenience of transmission, resulting from respective packet divisions of image signals, audio signals, and data signals corresponding to outputs of the encoding apparatuses (the output being referred to as an elementary stream, ES). By attaching and encapsulating TS packet headers to PES packets, TS packets constituting the TS may be generated.

The header of the TS packet includes, as main information, packet identifier (PID), continuity counter (CC), program clock reference (PCR) information, etc. Here, the PID is an identifier for the TS packet and is allocated for each PES packet. CC is a sequence number for giving continuity to TS packets, and it is formed of a 4-bit data field.

The PCR information is a value obtained by sampling a time set in the encoding device and refers to a time reference applied to a specific PID. The PCR information includes a PCR flag and a PCR value and is inserted into the header of the TS packet periodically to be transmitted at least once within 0.1 seconds.

In transmitting the TS packet by using the multicast method, the IPTV headend may use a User Datagram Protocol (UDP) method or a Real-Time Transport Stream (RTP) method. This embodiment is limited to using the UDP method for practical measures against packet loss.

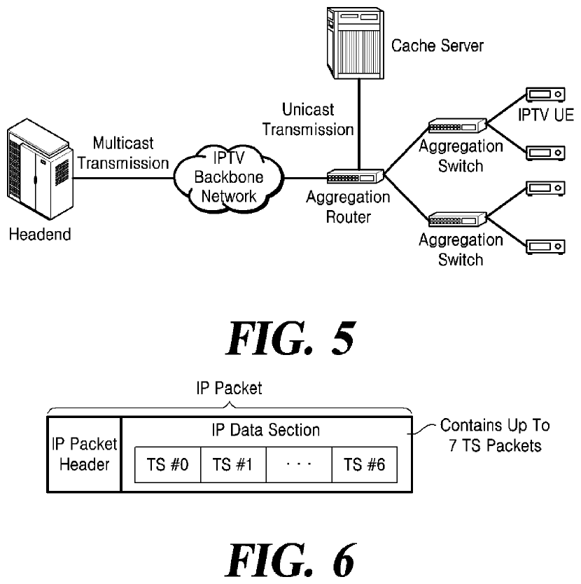

FIG. 6 is a schematic block diagram of an IP packet obtained by encapsulating TS packets.

An IP packet multicast in an IP network may include up to 7 TS packets. This embodiment assumes that one IP packet includes 7 TS packets. An IP packet includes a header and a data section. The illustration of FIG. 6 assumes that the IP data section 6 includes a header (not shown) of a UDP packet resulting from encapsulating the multiple TS packets. When the packet originating from the content-providing apparatus is moved to the IPTV UE by using the IPTV backbone network and the router/switches, an error occurring in the travel path may cause improper delivery of the IP packet to the IPTV UE, resulting in the lost packet. Such packet loss can neither be identified nor be recovered from only the information included in the received IP header and UDP header. Accordingly, this embodiment discloses a method of identifying and recovering packet loss by using the main information included in the headers of TS packets.

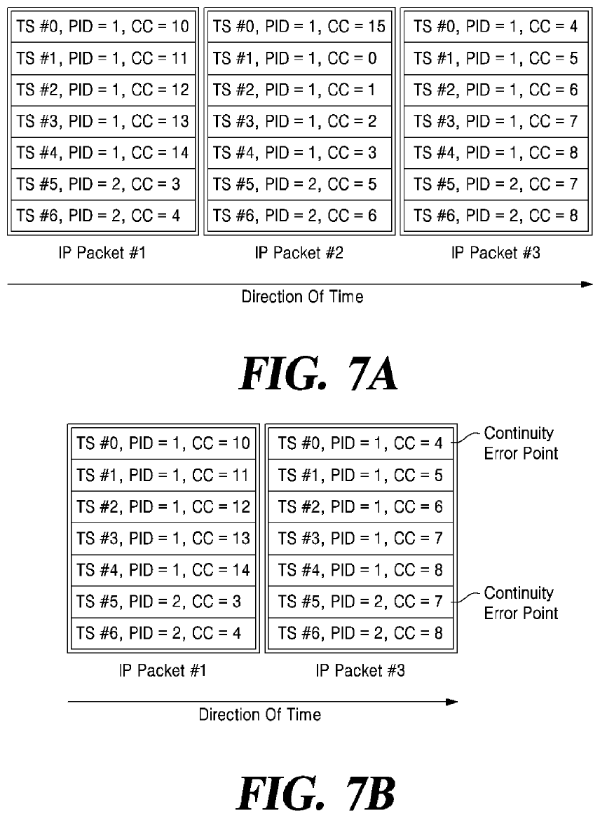

FIGS. 7A and 7B illustrate examples of header information of TS packets received by an IPTV UE.

When the IPTV UE has received the IP packets normally without error, header information of the TS (transport stream) packets may be expressed as illustrated in FIG. 7A, wherein the CC (continuity counter) assigned to a specific PID (packet identifier) increments by one. On the other hand, when a mistake happens in the process of receiving an IP packet (e.g., when IP packet #2 is lost), as illustrated in FIG. 7B, where the CCs assigned to the PIDs of specific TS packets are discontinuous, continuity errors occur as shown. Therefore, upon identifying a continuity error in the TS packet, the IPTV UE may consider that at least one IP packet is lost. However, the continuity error can provide no accurate information on the packet loss but the occurrence of the packet loss. With the continuity error occurring due to a lost IP packet, the IPTV UE may face serious performance degradation in the content restoration and reproduction process.

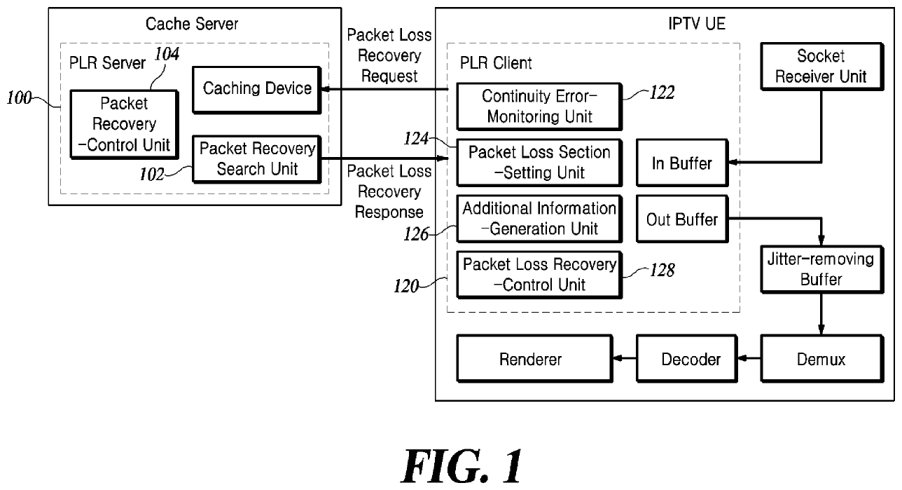

FIG. 1 is a block diagram of a packet loss recovery apparatus according to at least one embodiment of the present disclosure.

The packet loss recovery apparatus according to at least one embodiment, for use in an IPTV multicast service, utilizes additional information about the packet loss received from the IPTV UE for rendering a cache server to identify a lost packet and send the IPTV UE a recovery packet corresponding to the lost packet in a unicast manner. The packet loss recovery apparatus may include a packet loss recovery (PLR) server 100 within the cache server and a PLR client 120 within IPTV UE.

Using a socket receiver unit as shown in FIG. 1, the IPTV UE receives the multicast transmission of IP packets from the IPTV headend and then checks for a continuity error of the TS packets. Even when identifying IP packet loss due to a continuity error, as described above, the continuity error means that some IP packets are lost, but it does not inform of the number and location of lost packets. Accordingly, the PLR client 120 generates additional information necessary for the recovery of the lost packet by using the header information of the received TS packet related to the continuity error, and it then transmits the generated additional information to the cache server. In response to the packet loss recovery request from the PLR client 120, the PLR server 100 generates a relevant packet loss recovery response. For example, the PLR server 100 utilizes caching data, and the additional information received from the IPTV UE to detect the exact location of the lost packet, and sends the IPTV UE a recovery packet corresponding to the lost packet in a unicast manner. The PLR client 120 may recover the packet loss by using the recovery packet obtained from the cache server.

Additionally, the IPTV UE adjusts the delay difference between the received or recovered TS packets by using a jitter-removing buffer, and utilizes a demux, a decoder, and a renderer sequentially to reproduce the content of the selected channel from the delay-adjusted packets. Since the description of other components of the IPTV UE except for the PLR client 120 is out of the scope of the present disclosure, a further detailed description thereof will be omitted.

FIG. 1 is an exemplary configuration according to the present embodiment, and the present disclosure envisions various implementations including other components or other connections between the components depending on the architecture of the PLR server and the architecture of the PLR client.

Since the continuity error uses information included in the header of the TS packet, unless otherwise limited, the packet hereinafter indicates a TS packet unless otherwise defined. Additionally, a packet received by the IPTV UE is expressed as a received TS packet, and a packet stored as caching data by the cache server is expressed as a transmitted TS packet.

Additionally, before the description of the generation of additional information and the packet loss recovery process, terms related to packet loss are defined as follows.

When the IPTV channel selected by the IPTV UE includes N (N is a natural number) elementary streams (ESs) with packet identifiers (PIDs) being allocated respectively to the packetized elementary streams (PESs) corresponding to the ESs, the entire PID set may be expressed as shown in Equation 1.

{pid₁, pid₂, . . . , pidᵢ, . . . , pid_{N}} Equation 1

Here, pidᵢ represents the PID for the i-th PES included in the selected channel. As shown in FIG. 7A, the TS packet multiplexes PESs with a plurality of PIDs. Additionally, the continuity counter (CC) value for pidᵢ may be expressed as shown in Equation 2.

{cc_{pid}_{ᵢ}¹, cc_{pid}_{ᵢ}², . . . , cc_{pid}_{ᵢ}^{j}, . . . } Equation 2

Here, cc_{pid}_{ᵢ}^{j} represents the j-th received CC value for pidᵢ. When some IP packets are lost, the IPTV UE can identify a continuity error by using the condition shown in Equation 3.

(cc_{pid}_{ᵢ}^{j}+1)mod 16≠cc_{pid}_{ᵢ}^{j+1} Equation 3

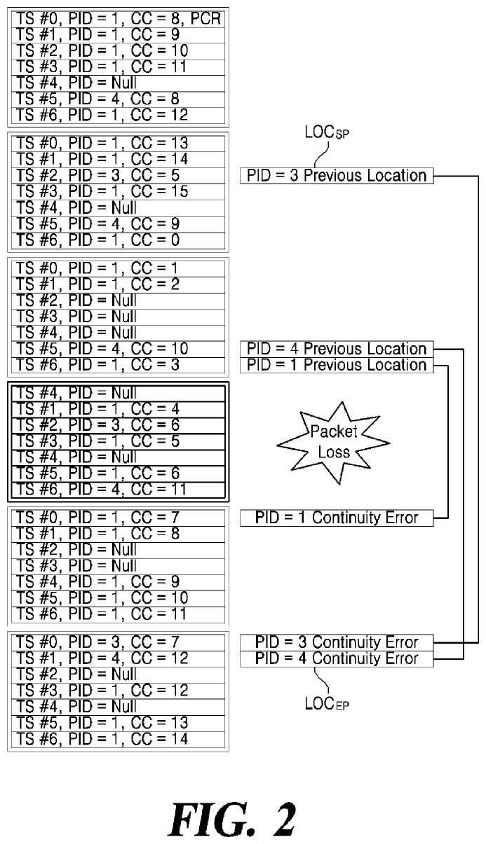

FIG. 2 is a schematic diagram of a packet loss section according to at least one embodiment of the present disclosure.

As described above, since the continuity error does not inform of the number and location of lost packets, the present disclosure may set a packet loss section [LOC_{SP}, LOC_{EP}] presumed to have an occurrence of packet loss. Here, LOC denotes a location, SP denotes a starting position, and EP denotes an end position.

For one PID (packet identifier), the packet loss section may be defined as an interval between and inclusive of two TS packets including the CC values signifying the continuity error. Therefore, for all N PIDs, as illustrated in FIG. 2, the entire packet loss section is defined as the union of the packet loss sections for the PIDs involved in the continuity error. The setting of the packet loss section may be expressed as a process of setting LOC_{SP} and LOC_{EP} as shown in Equations 4 and 5.

LOC_{SP}=min(Cand_{SP})

Cand_{SP}={ts_loc(cc_{pid}_{ᵢ}^{j})|∀i and ∀j(cc_{pid}_{ᵢ}^{j}+1)mod 16≠cc_{pid}_{ᵢ}^{j+1}} Equation 4

LOC_{EP}=max(Cand_{EP})

Cand_{EP}={ts_loc(cc_{pid}_{ᵢ}^{j+1})|∀i and ∀j(cc_{pid}_{ᵢ}^{j}+1)mod 16≠cc_{pid}_{ᵢ}^{j+1}} Equation 5

Here, ts_loc(·) means the location of the TS packet. Cand_{SP} indicates candidates for LOC_{SP}, and Cand_{EP} indicates candidates for LOC_{EP}.

In the packet loss recovery apparatus according to the present embodiment, the PLR client 120 sets a packet loss section by using header information of a TS packet related to a continuity error, and generates, based on the packet loss section, additional information necessary for recovering a lost TS packet, and then sends the cache server the generated additional information. Additionally, the PLR client 120 recovers the packet loss by using the recovery packet obtained from the cache server. The PLR client 120 may include a continuity error-monitoring unit 122, a packet loss section-setting unit 124, an additional information-generating unit 126, and a packet loss recovery-control unit 128 in whole or in part. Further, the PLR client 120 may include an in-buffer and an out-buffer necessary for generating additional information and recovering packet loss. Meanwhile, it is assumed that the IPTV UE includes a transceiver (not shown) used for the transmission of additional information and reception of recovery packets.

The continuity error-monitoring unit 122 checks whether a continuity error occurs by using header information of the received TS packets. When the IPTV UE receives the IP packets and stores them in the in-buffer, the continuity error-monitoring unit 122 may use the condition shown in Equation 3 based on the received TS packets included in the IP packets to identify a continuity error related to the packet loss.

The packet loss section-setting unit 122 determines the packet loss section by using the header information of the received TS packets related to the continuity error. Using the process shown in Equations 4 and 5, the packet loss section-setting unit 122 may set the starting position and the end position of the packet loss section encompassing the lost TS packet.

The additional information-generation unit 126 generates, based on the packet loss section, additional information necessary to recover the lost TS packet and then transmits the generated additional information to the cache server.

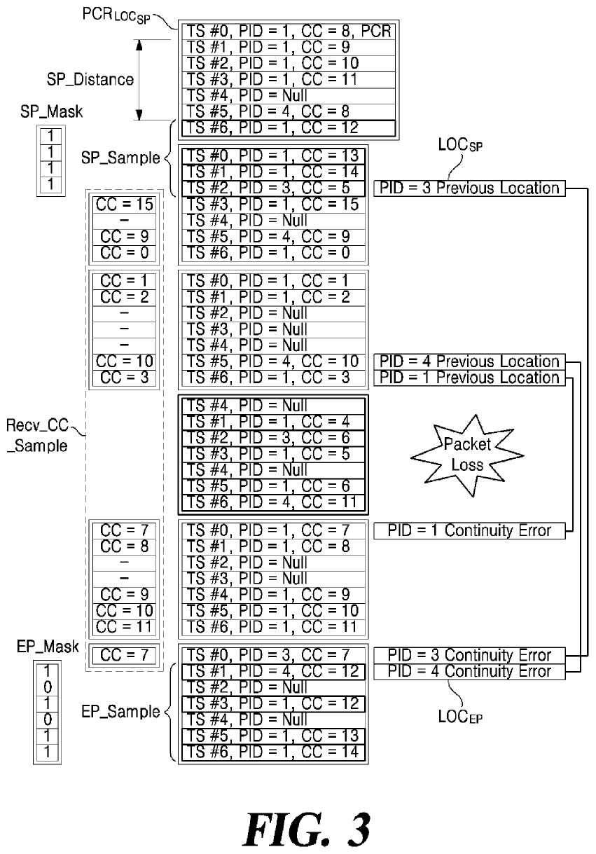

FIG. 3 is a schematic diagram of additional information according to at least one embodiment of the present disclosure.

Definitions of the additional information illustrated in FIG. 3 are as shown in Table 1.

TABLE 1

| Item | Description |
|---|---|
| PCR_{LOC}_{_{SP}} | The position of the received TS packet including the |
| | PCR value most preceding LOC_{SP} which is the |
| | starting position of the packet loss section. |
| SP_Sample | Sample data for M (M is a natural number) received |
| | TS packets (but TS null packets) including a TS |
| | packet corresponding to a LOC_{SP} and a preceding |
| | TS packet |
| SP_Mask | Bit mask for distinguishing TS null packets not |
| | included in SP_Sample |
| SP_Distance | Distance between TS packet including PCR_{LOC}_{_{SP}} |
| | and received TS packets included in SP_Sample |
| EP_Sample | Sample data for M received TS packets (but TS null |
| | packets) including a TS packet corresponding to a |
| | LOC_{EP} and the trailing TS packet |
| EP_Mask | Bit mask for distinguishing TS null packets not |
| | included in SP_Sample |
| Recv_CC_Sample | In the packet loss section, a list containing CC |
| | values corresponding to accurately received TS |
| | packets. |

Here, the TS null packet is a packet having no PES allocated, and includes no meaningful information. Additionally, the components included in the additional information according to the present embodiment are not necessarily limited to the items shown in Table 1, and any element necessary for the recovery of packet loss may be included in the additional information.

The packet loss recovery-control unit 128 recovers the lost TS packet by using the recovery packet obtained from the cache server. The recovered TS packet may be stored in the out-buffer and used in a subsequent execution process of the IPTV UE.

The PLR server 100 of the packet loss recovery apparatus according to this embodiment utilizes the additional information about the packet loss received from the IPTV UE, and the cached data to detect the exact location of the lost TS packet, and sends the IPTV UE a recovery packet corresponding to the lost TS packet in a unicast manner. The PLR server 100 includes a packet recovery search unit 102 and the packet recovery-control unit 104 in whole or in part. The PLR server 100 may further include a caching device for storing a sequence of TS packets transmitted to the IPTV UE using a multicast method, to use the caching device in searching for lost packets. Meanwhile, it is assumed that the cache server includes a transceiver (not shown) used for receiving the additional information and transmitting the recovery packet.

The packet recovery search unit 102 utilizes the additional information on the packet loss received from the IPTV UE and the cached data for checking the exact location of the lost TS packet. The packet recovery search unit 102 may utilize the additional information shown in Table 1 and the transmitted TS packet sequence stored in the cache device to search for the exact location of the lost TS packet.

The packet recovery search unit 102 adds SP_Distance to PCR_{LOC}_{_{SP}} and thereby sets a Search_Point for searching in the sequence of transmitted TS packets stored in the cache device.

The packet recovery search unit 102 compares M (M is a natural number) transmitted TS packets after the Search_Point with the received TS packets included in SP_Sample. In this case, since the TS null packet inferred according to SP_Mask has no meaningful information, it is excluded from the comparison. When they are compared to be equal, Search_Start_Point is set to be the ‘current Search_Point+M’ value. On the other hand, if they are compared to be unequal, the packet recovery search unit 102 may set Search_Start_Point by incrementing Search_Point by one while repeating the above-described process until the two in comparison become equal.

Similar to the method applied to the SP_Sample, the packet recovery search unit 102 utilizes the EP_mask for comparing thereto the TS packets after the Search_Start_Point. At this time, since the TS null packet inferred according to EP_Mask does has no meaningful information, it is excluded from the comparison. When they are compared to be equal, Search_End_Point is set to the current Search_Point value. On the other hand, when they are compared to be unequal, the packet recovery search unit 102 may set Search_End_Point by incrementing Search_Point by one while repeating the above-described process until the two in comparison become equal.

The packet recovery-search unit 102 sets the section from Search_Start_Point to Search_End_Point as the search section for the lost TS packet, and compares the transmitted TS packets existing in the search section with Recv_CC_Sample, and thereby searches for the TS packet having unmatched CC values to identify a lost TS packet. In this case, when a single IP packet is set to include 7 TS packets, the searched TS packets need to be grouped into a group including seven consecutive TS packets. The TS packet grouped in this way may be a recovery packet required by the IPTV UE.

The packet recovery-control unit 104 transmits a recovery packet corresponding to the lost TS packet to the IPTV UE in a unicast manner.

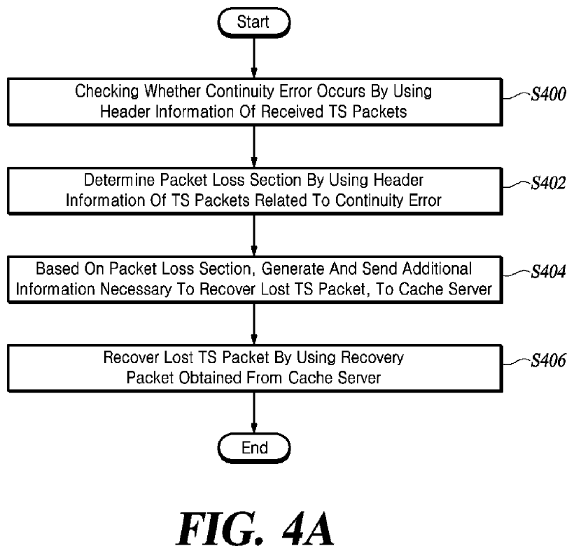

FIGS. 4A and 4B are flowcharts of a packet loss recovery method according to at least one embodiment of the present disclosure.

FIG. 4A illustrates a flowchart of a packet loss recovery method performed by the PLR client 120 of the packet loss recovery apparatus, and FIG. 4B illustrates a packet loss recovery method performed by the PLR server 100 of the packet loss recovery apparatus.

The PLR client 120 checks whether a continuity error occurs by using header information of the received TS packets (S400). When the IPTV UE receives the IP packets, the method may identify a continuity error related to packet loss by using the condition shown in Equation 3 based on the received TS packets included in the IP packets.

The PLR client 120 determines the packet loss section by using the header information of the received TS packets related to the continuity error (S402). Using the process shown in Equations 4 and 5, the method may set the starting position and end position of the packet loss section encompassing the lost TS packet.

The PLR client 120 generates, based on the packet loss section, additional information necessary to recover the lost TS packet and then transmits the generated additional information to the cache server (S404). Here, the definition of the additional information is shown in Table 1.

The PLR server 100 receives additional information about the lost TS packet from the IPTV UE (S420).

The PLR server 100 utilizes the additional information to set a search section among a sequence of transmitted TS packets stored in the caching device and searches over the search section to identify a lost TS packet (S422).

The process of identifying the lost TS packet based on the additional information as shown in Table 1 may be subdivided as follows.

The PLR server 100 sets a Search_Point for the search (S430). The PLR server 100 may set Search_Point by adding SP_Distance to PCR_{LOC}_{_{SP}}.

The PLR server 100 compares the transmitted TS packets after Search_Point with the received TS packets included in the SP_Sample to calculate the starting position of the search section (S432).

The PLR server 100 compares the transmitted TS packets after the starting position with the received TS packets included in the EP_Sample to calculate the end position of the search section (S434).

The PLR server 100 identifies the lost TS packet by searching for a transport TS packet existing in the search section by using Recv_CC_Sample (436).

The PLR server 100 transmits a recovery packet corresponding to the lost TS packet to the IPTV UE in a unicast manner (S424). The PLR server 100 may extract a recovery packet corresponding to the lost TS packet in the search section and transmit the recovery packet to the IPTV UE.

The PLR client 120 recovers the lost TS packet by using the recovery packet obtained from the cache server (S406). The recovered TS packet may be used in a subsequent execution process of the IPTV UE.

As described above, the packet loss recovery apparatus and method, provided for use in an IPTV multicast service according to some embodiments of the present disclosure, can allow a cache server to identify a lost packet by using additional lost-packet information received from an IPTV UE and send the IPTV UE a recovery packet corresponding to the lost packet and thereby recover the packet loss in the multicast service process.

Further, the packet loss recovery apparatus and method, provided for use in the IPTV multicast service according to some embodiments, can allow the cache server to identify a lost packet by using additional lost-packet information received from an IPTV UE and send the IPTV UE a recovery packet corresponding to the lost packet, thereby allowing the use of the User Datagram Protocol (UDP) method, achieving accurate detection and transmission of the lost packet based on the structural characteristics of TS packets.

Although some embodiments of the present disclosure present flowcharts with the steps thereof illustrated as being sequentially performed, they merely instantiate the technical idea of some embodiments of the present disclosure. Therefore, a person having ordinary skill in the pertinent art could incorporate various modifications, additions, and substitutions in practicing the present disclosure by changing the sequence of steps described by the respective flowcharts or by performing one or more of the steps in the flowcharts in parallel, and hence the steps in the respective flowcharts are not limited to the illustrated chronological sequences.

Various implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) contain instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording medium may further include transitory medium such as a carrier wave (e.g., transmission through the Internet) and data transmission medium. Further, the computer-readable recording medium can be distributed in computer systems connected via a network, wherein the computer-readable codes can be stored and executed in a distributed mode.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

### CROSS-REFERENCE TO RELATED APPLICATION

This application claims priority from Korean Patent Application No. 10-2020-0073703 filed on Jun. 17, 2020, the disclosure of which is incorporated by reference herein in its entirety.

1. A method performed by a cache server for recovering a packet loss, the method comprising:
receiving, from an internet protocol television (IPTV) user equipment (UE), additional information on a lost TS packet from among received transport stream (TS) packets of the IPTV UE;
setting a search section in a pre-stored sequence of transmitted TS packets by using the additional information, and identifying the lost TS packet by searching over the search section; and
extracting, from the search section, a recovery packet corresponding to the lost TS packet and transmitting the recovery packet to the IPTV UE in a unicast manner.

2. The method of claim 1, wherein the additional information is information about a packet loss section generated by the IPTV UE using a continuity error and comprises in whole or in part:
a program clock reference (PCR) location most preceding a starting position of the packet loss section;
a starting interval between the starting position and the PCR position;
preceding sample data corresponding to M (M is a natural number) received TS packets including a TS packet preceding the starting position;
trailing sample data corresponding to M received TS packets trailing an end position of the packet loss section; and
a continuity counter (CC) sample list including CC values corresponding to accurately received TS packets in the packet loss section.

3. The method of claim 2, wherein the continuity error comprises:
a failure to maintain continuity of CC values for at least one or more packet identifiers (PIDs) included in the received TS packets.

4. The method of claim 2, wherein the packet loss section, which is defined with respect to N (N is a natural number) PIDs included in the received TS packets, represents a union of packet loss intervals for the PIDs involved in the continuity error, wherein a packet loss interval for each PID spans two TS packets including the CC values signifying the continuity error.

5. The method of claim 2, wherein the identifying of the lost TS packet comprises:
setting a search position by adding the starting interval to the PCR position;
calculating a starting position of the search section by comparing the transmitted TS packets existing after the search position with the preceding sample data;
calculating an end position of the search section by comparing the transmitted TS packets existing after the starting position with the trailing sample data; and
identifying the lost TS packet by searching over the transmitted TS packets existing in the search section by using the CC sample list.

6. A method performed by an internet protocol television (IPTV) user equipment (UE), the method comprising:
checking whether a continuity error occurs by using header information of received transport stream (TS) packets;
determining a packet loss section by using header information of the received TS packets related to the continuity error;
generating, based on the packet loss section, additional information necessary for recovering a lost TS packet and transmitting the generated additional information to a cache server; and
recovering the lost TS packet by using a recovery packet obtained from the cache server.

7. The method of claim 6, wherein the additional information comprises in whole or in part:
a program clock reference (PCR) location most preceding a starting position of the packet loss section;
a starting interval between the starting position and the PCR position;
preceding sample data corresponding to M (M is a natural number) received TS packets including a TS packet preceding the starting position;
trailing sample data corresponding to M received TS packets trailing an end position of the packet loss section; and
a continuity counter (CC) sample list including CC values corresponding to accurately received TS packets in the packet loss section.

8. The method of claim 7, wherein the continuity error comprises:
a failure to maintain continuity of CC values for at least one or more packet identifiers (PIDs) included in the received TS packets.

9. The method of claim 7, wherein the packet loss section, which is defined with respect to N (N is a natural number) PIDs included in the received TS packets, represents a union of packet loss intervals for the PIDs involved in the continuity error, wherein a packet loss interval for each PID spans two TS packets including the CC values signifying the continuity error.

10. A non-transitory computer-readable medium storing instructions, when being executed by a computer, cause the computer to perform:
receiving, from an internet protocol television (IPTV) user equipment (UE), additional information on a lost TS packet from among received transport stream (TS) packets of the IPTV UE;
setting a search section in a pre-stored sequence of transmitted TS packets by using the additional information, and identifying the lost TS packet by searching over the search section; and
extracting, from the search section, a recovery packet corresponding to the lost TS packet and transmitting the recovery packet to the IPTV UE in a unicast manner.

11. The non-transitory computer-readable medium of claim 10, wherein the additional information is information about a packet loss section generated by the IPTV UE using a continuity error and comprises in whole or in part:
a program clock reference (PCR) location most preceding a starting position of the packet loss section;
a starting interval between the starting position and the PCR position;
preceding sample data corresponding to M (M is a natural number) received TS packets including a TS packet preceding the starting position;
trailing sample data corresponding to M received TS packets trailing an end position of the packet loss section; and
a continuity counter (CC) sample list including CC values corresponding to accurately received TS packets in the packet loss section.

12. The non-transitory computer-readable medium of claim 11, wherein the continuity error comprises:
a failure to maintain continuity of CC values for at least one or more packet identifiers (PIDs) included in the received TS packets.

13. The non-transitory computer-readable medium of claim 11, wherein the packet loss section, which is defined with respect to N (N is a natural number) PIDs included in the received TS packets, represents a union of packet loss intervals for the PIDs involved in the continuity error, wherein a packet loss interval for each PID spans two TS packets including the CC values signifying the continuity error.

14. The non-transitory computer-readable medium of claim 11, wherein the identifying of the lost TS packet comprises:
setting a search position by adding the starting interval to the PCR position;
calculating a starting position of the search section by comparing the transmitted TS packets existing after the search position with the preceding sample data;
calculating an end position of the search section by comparing the transmitted TS packets existing after the starting position with the trailing sample data; and
identifying the lost TS packet by searching over the transmitted TS packets existing in the search section by using the CC sample list.
